(19) United States
(12) Patent Application Publication
(10) Pub. No.: US 2012/0092630 A1
(43) Pub. Date: Apr. 19, 2012

(54) PROJECTION TYPE DISPLAY DEVICE AND LIGHT AMOUNT ADJUSTMENT METHOD

(76) Inventors: Kunitaka Furuichi, Tokyo (JP); Takayuki Okada, Tokyo (JP)

(21) Appl. No.: 13/380,009

(22) PCT Filed: Jul. 31, 2009
(86) PCT No.: PCT/JP2009/063652

§ 371 Date: Dec. 21, 2011

(51) Int. Cl. G03B 21/28

(52) U.S. Cl. 353/98; 353/121

(57) ABSTRACT

A projection type display device that displays an image with projected light onto a target to he projected, including a first sensor (12) that detects reflected light of the projected light; a second sensor (13) that detects an infrared ray in a predetermined range in an optical path direction of the projected light; and a light amount deciding section (23) that decides an amount of the projected light based on the amount of reflected light detected by the first sensor (12) and an amount of change of the infrared ray detected by the second sensor (13).

### TECHNICAL FIELD

The present invention relates to a projection type display device that displays images that are generated by projected light on a target to be projected and also to a light amount adjustment method.

### BACKGROUND ART

Since projection type display devices have been increasingly used under bright environments in recent years, high brightness characteristics have been achieved for them. In projection type display devices with high brightness characteristics, the amount of light that is to be projected from a projection lens to a target, such as a screen, becomes large.

Thus, when a person who enters a projection area directly watches projected light, he or she might have a strong stimulation on his or her eyes and feel discomfort thereon. On the other hand, when an object rather than a person enters a projection area in the neighborhood of the projection lens, since the amount of projected light is large especially in the neighborhood of the projection lens, the temperature of the object may rise. When an object that enters the projection area is a cloth, it might discolor; when the object is a data storage medium used for an electronic device, its temperature might exceed its durable temperature limits.

To deal with such a situation, there is demand for technologies that allow the amount of projected light to automatically decrease in the case in which a person or an object enters the projection area, and such technologies are disclosed, for example, in Patent Literatures 1 to 3.

The technology disclosed in Patent Literature 1 is provided with a plurality of human sensors (pyroelectric infrared sensors) in the neighborhood of the projection lens of a projection type display device. The projection area is segmented into a plurality of areas corresponding to the human sensors and the plurality of human sensors placed in the plurality of areas sense a person. The projection type display device decreases the amount of projected light for areas that the human sensors sense a person.

Since the foregoing technology decreases the amount of projected light only for areas in which a person is present, the loss of images projected on the target to be projected can be suppressed to the minimum.

On the other hand, the technology disclosed in Patent Literature 2 is provided with two detection devices that detect an object and that are arranged on both lateral sides of a projection type display device. The detection devices each emit a collimated infrared beam to the neighborhood of the outer edge of the projection area. When the detection devices receive the emitted infrared beams reflected by an object, the projection type display device decreases the amount of projected light of the infrared beams. The detection devices can receive light reflected by an object that is present in a predetermined distance from the detection devices.

The foregoing technology can set up the projection type display device such that the amount of projected light does not decrease when a presenter stands by a screen. This can be accomplished by causing the predetermined distance to be shorter than the distance from the detection devices to the presenter.

The technology disclosed in Patent Literature 3 captures a projection area with a CCD (Charge Coupled Device) camera, detects the position in which a person is present, and decreases the amount of projected light for an area corresponding to the detected position.

Like the technology disclosed in Patent Literature 2, the technology disclosed in Patent Literature 3 can partly decrease the amount of projected light. In addition, since this technology detects the position in which a person is present based on information captured by the CCD camera, this technology can precisely adjust the amount of projected light corresponding to the position in which a person is present.

### RELATED ART LITERATURE

### Patent Literature

Patent Literature 1: JP2006-091121A, Publication

Patent Literature 2: JP2001-075170A, Publication

Patent Literature 3: JP2000-305481A, Publication

### SUMMARY OF THE INVENTION

### Problems to be Solved by the Invention

The foregoing technology disclosed in Patent Literature 1 provides a plurality of human sensors in the neighborhood of the projection lens. Since the detection areas of the human sensors are very limited in the neighborhood of the human sensors, detection impossible areas in which the human sensors cannot detect a person who enters the neighborhood of the projection lens arise. In particular, if a detection area is optimally set up for a projection area, as a problem arises in which the detection impossible areas become large (first problem).

In addition, the human sensors used in the foregoing technology can detect only the presence of a person, but can not measure the distance to him or her. If the distance between each of the human sensors and the person is so far that the brightness of the projected light is negligible, although the amount of projected light does not need to be decreased, as a problem that arises in the foregoing technology, even if a person is present in an area where the amount of projected light is low and thereby it does not need to be decreased, the amount of projected light in the area is inevitably decreased (second problem).

Like the technology disclosed in Patent Literature 2, the foregoing second problem can be solved by detection devices in which detection areas can be set up by taking into consideration the distance between each of the detection devices and the object. In addition, when a person enters the neighborhood of the projection lens, since he or she passes through the detection areas, the foregoing technology can solve the first problem.

Since the foregoing technology sets up the detection areas by taking into consideration the distance between each of the detection devices and the person, the technology uses a collimated infrared beam. Thus, the detection areas are limited to very narrow local areas in the neighborhood of the outer edge of the projection area. Thus, if a person who is bending down enters the projection area or if he or she who is short in height, for example, a child, mistakenly enters the projection area, since the foregoing technology cannot detect the person, it cannot automatically decrease the amount of projected light.

When a person passes through the detection areas at a high speed, the technology may not detect him or her.

Since recent projection type display devices are provided with a distortion correction function for projected images, even if they project images while they are largely tilted, they can display images in the correct direction. Thus, if the devices project images while they are largely tilted or they are used while they are hung from the ceiling, a person may enter the projection area without going through the detection areas.

To solve these problems, many detection devices may be provided such that their detection areas along the neighborhood of the outer edge of the projection area overlap with each other and thereby the detection area widens. However, this method is not practical because installation space is required, the size of the space that is required for devices to be installed is restricted, and an increase in costs will occur.

The technology disclosed in Patent Literature 3 that uses a CCD camera may solve the forgoing first and third problems.

However, since the foregoing technology needs to capture images with a CCD camera, the amount of data per frame becomes large and frames need to be captured at predetermined periods of time. Thus, as a problem that arises in this technology, since the amount of data to be processed becomes huge, it takes a considerable amount of time to detect a person and thereby the operation that decreases the amount of projected light is delayed. In addition, as a problem that arises, since the technology needs to use a large scale detection circuit, it increases the cost.

Moreover, to shorten the time to detect a person and quickly adjust the amount of projected light, it is necessary to further shorten the intervals of frames that are captured. In this case, the detection circuit further becomes large and thereby the cost proportionally increases.

Furthermore, to detect the position of a person in the image projection area, it is necessary to separate a real person's image from a projected image. If a person's image is projected as a projected image, it is very difficult to separate the real person's image from the projected image and thereby the obtained data need to be processed in a complicated manner and thereby the operation that decreases the amount of projected light is delayed.

A technology that solves such a delay in the operation is disclosed in the same literature. This technology easily detects the position in which a person is present based on captured image information of which a lower limited area of the image projection area is captured.

However, this technology assumes that the image of a real person is an image in which the real person is standing and, thus, unless the person is actually standing, this technology cannot be applied.

An object of the present invention is to provide a projection type display device and a light amount adjustment method that can quickly, adequately, and inexpensively adjust the amount of projected light based on an object and the area where it is present.

### Means that Solve the Problem

To accomplish the foregoing object, the present invention is a projection type display device that displays an image with projected light onto a target to be projected, comprising:

a first sensor that detects reflected light of said projected light;

a second sensor that detects an infrared ray in a predetermined range in an optical path direction of said projected light; and

a light amount deciding section that decides an amount of said projected light based on the amount of reflected light detected by said first sensor and an amount of change of the infrared ray detected by said second sensor.

In addition, the present invention is an optical amount adjustment method for a projection type display device that displays an image with projected light onto a target to be projected, comprising:

a process that detects reflected light of said projected light;

a process that detects an infrared ray in a predetermined range in an optical path direction of said projected light; and

a light amount deciding process that decides an amount of said projected light based on the amount of reflected light that is detected and an amount of change of the infrared ray that is detected.

### Effect of the Invention

According to the present invention, a projection type display device detects reflected light of projected light and an infrared ray in a predetermined range in the direction of the optical path of the projected light and decides the amount of projected light based on the detected amount of reflected light and the detected amount of change of infrared ray.

Thus, the amount of projected light can be quickly, adequately, and inexpensively adjusted based on the object and area where it is present.

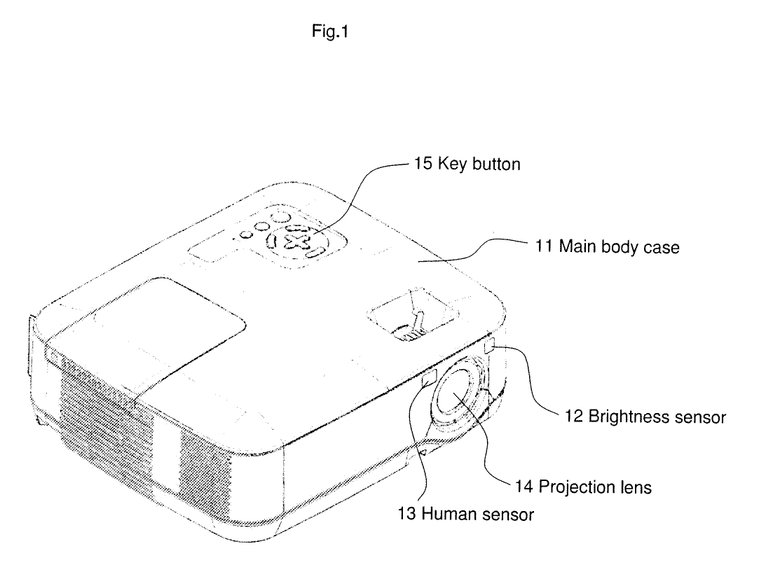

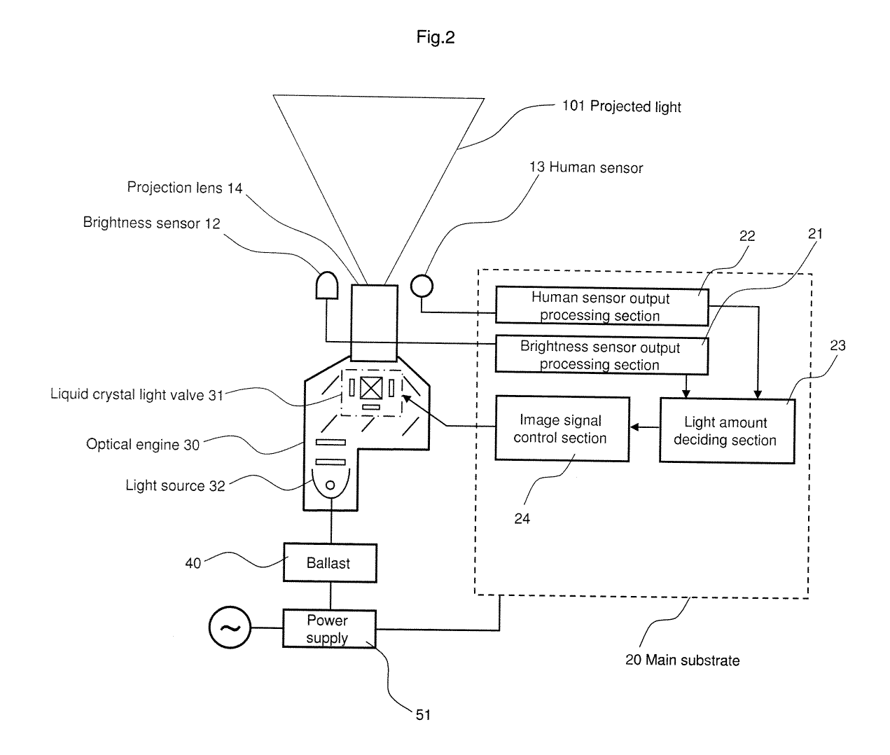

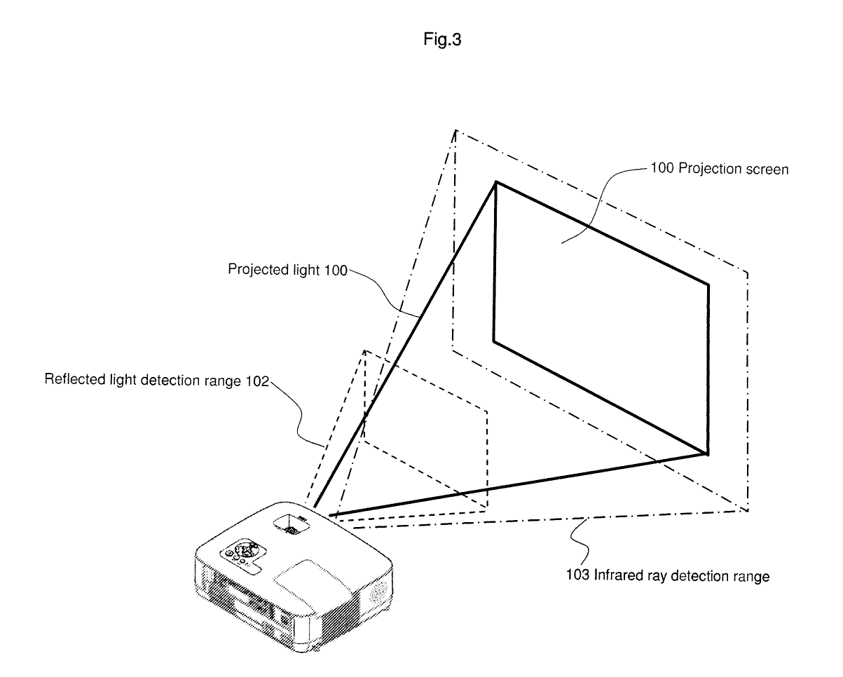

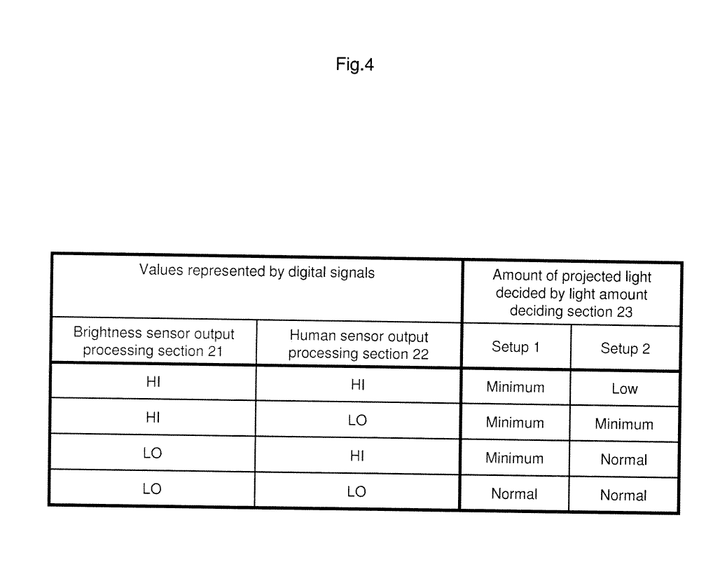

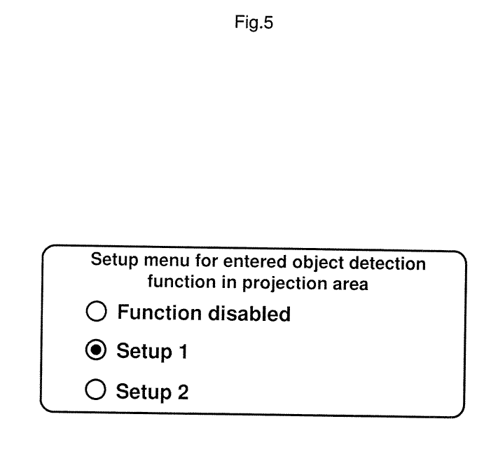

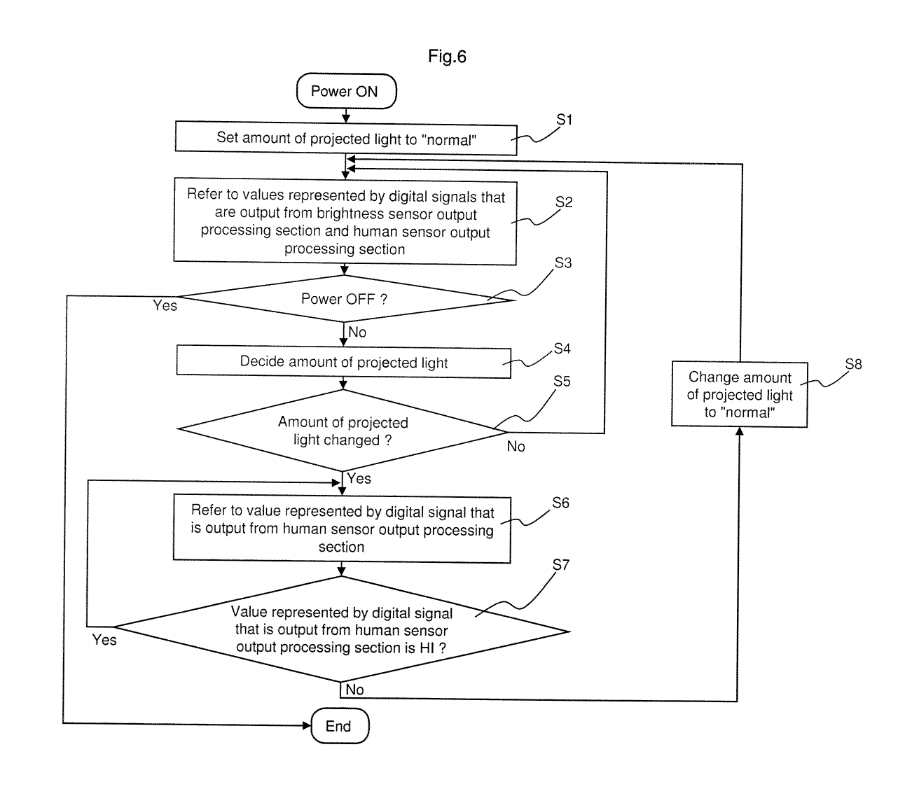

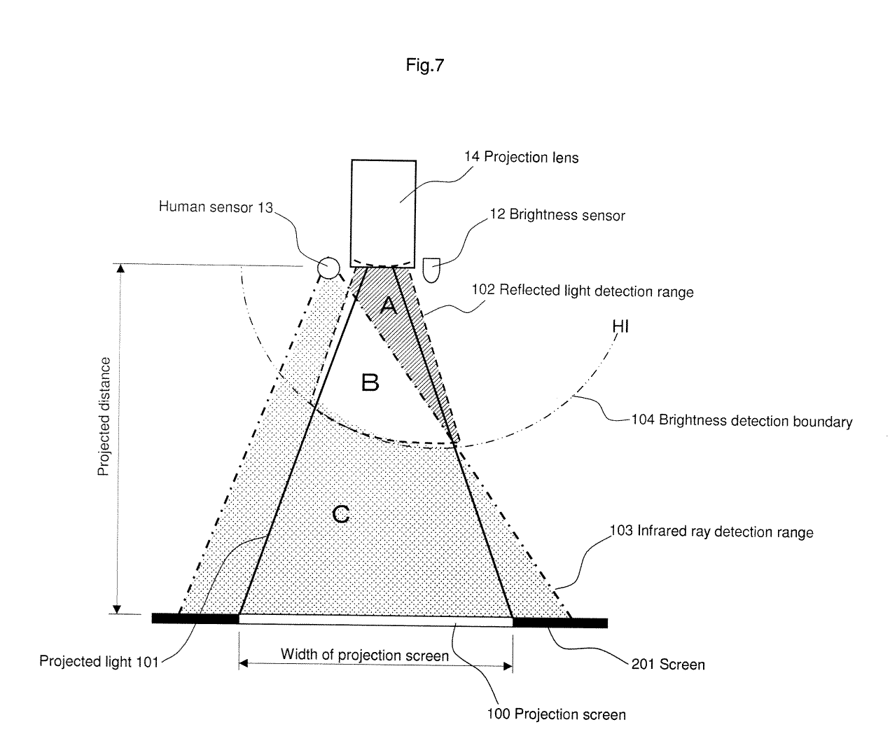

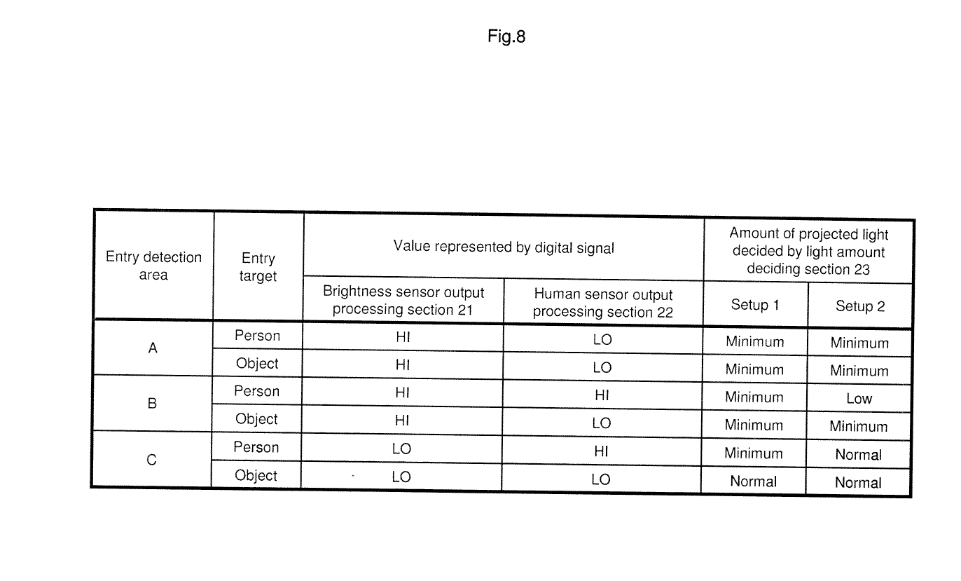

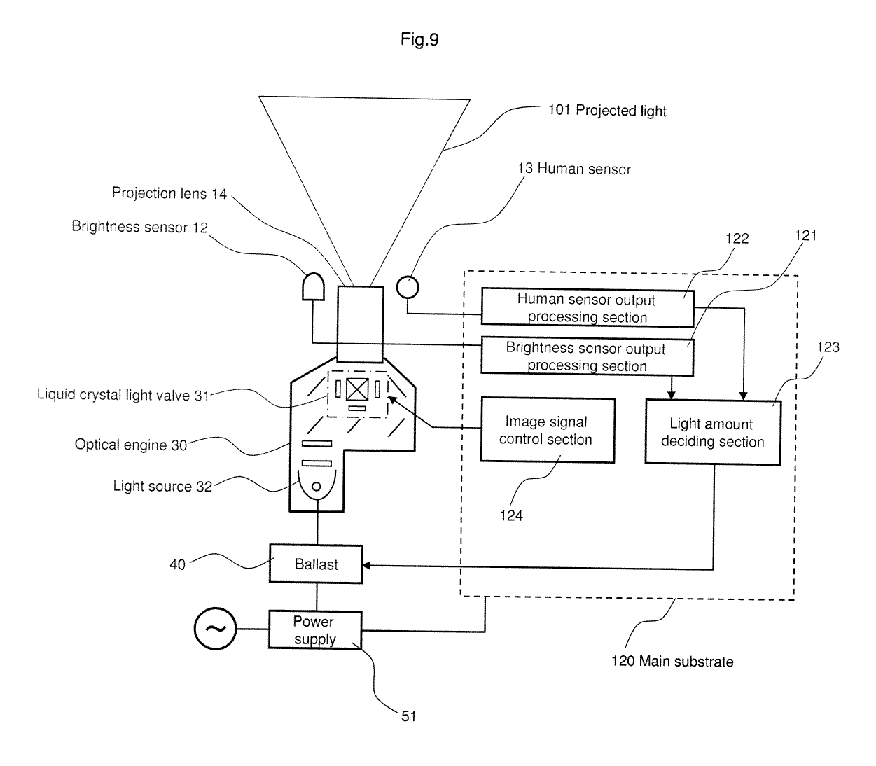

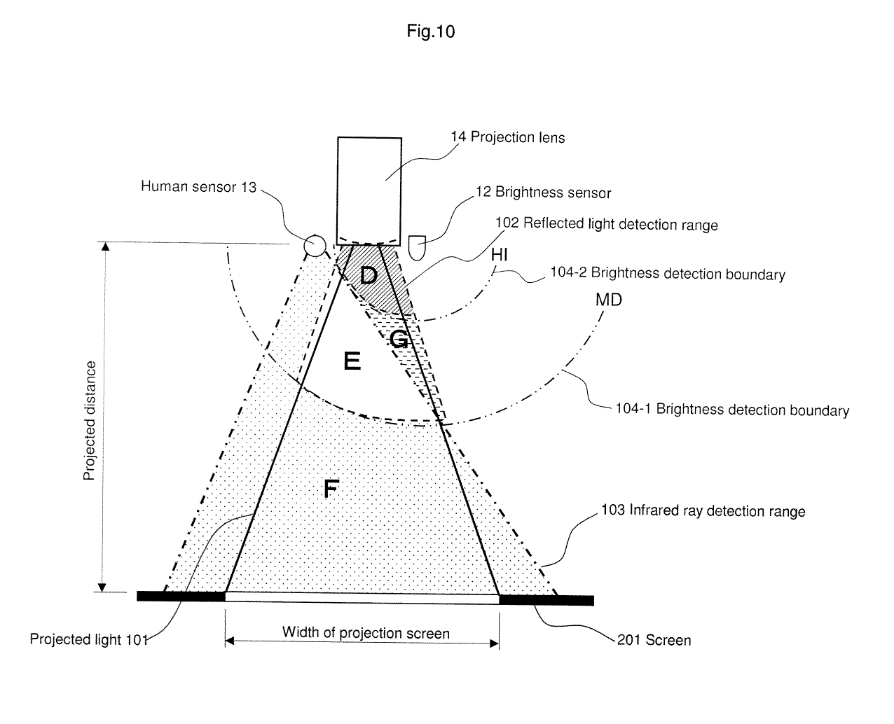

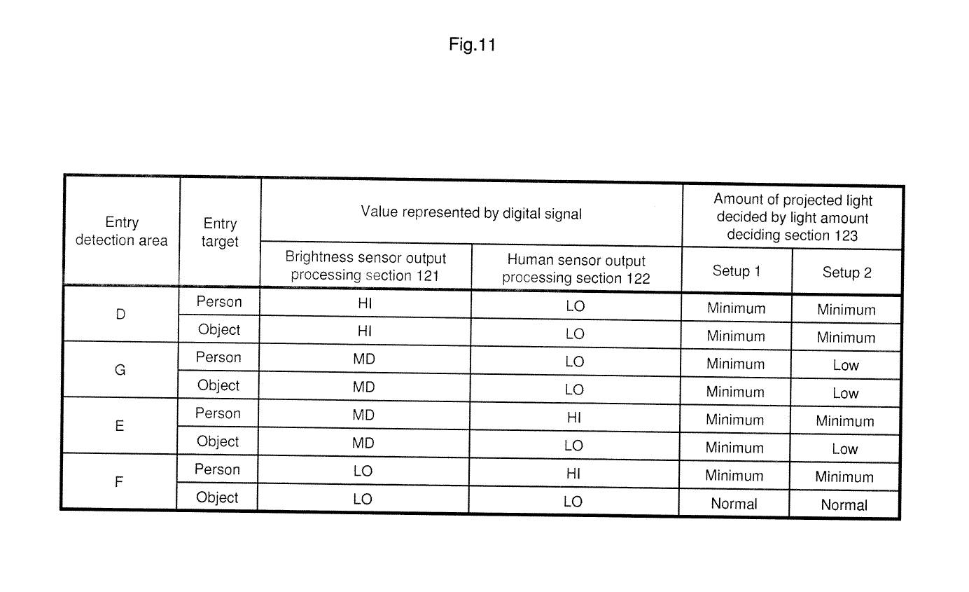

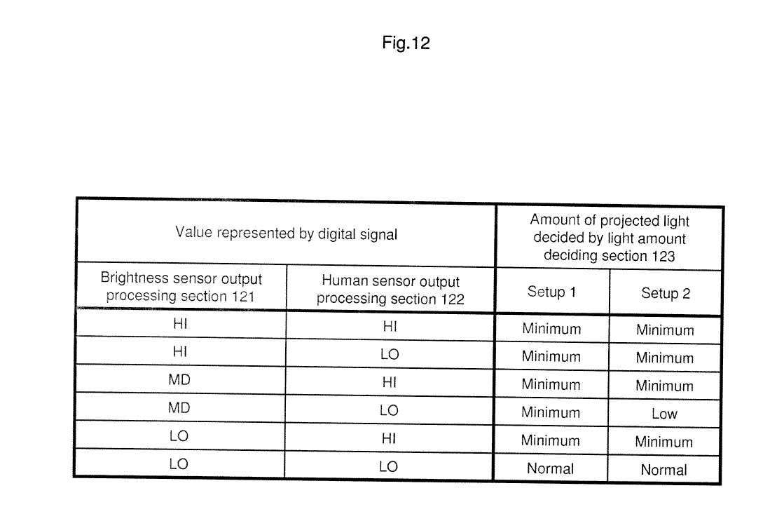

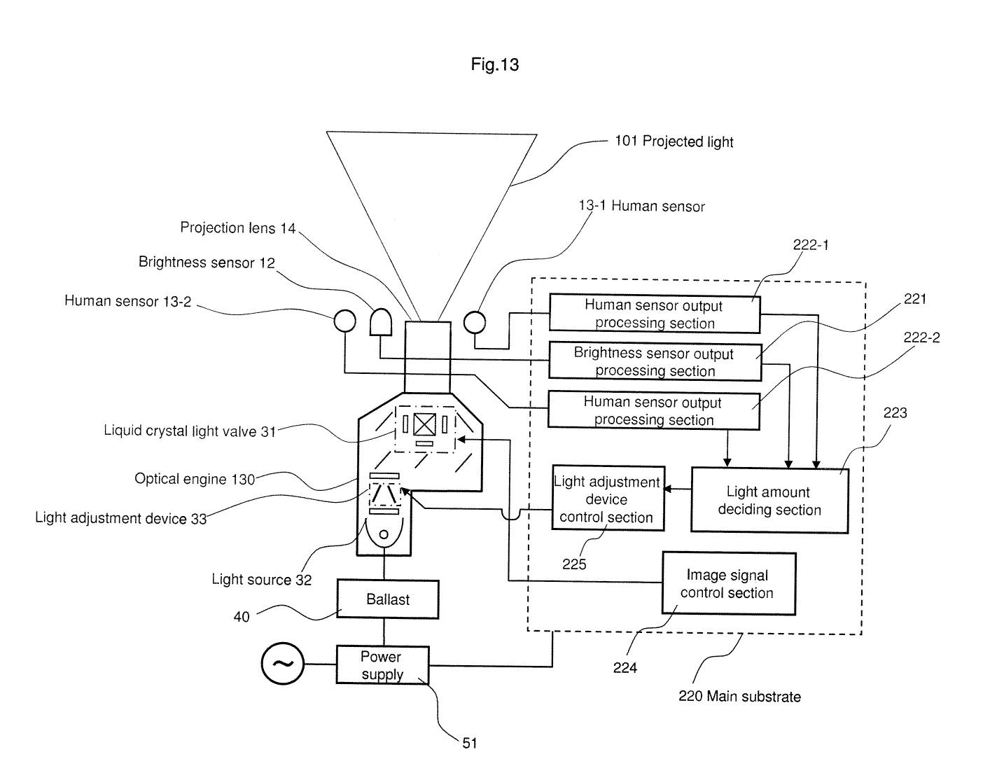

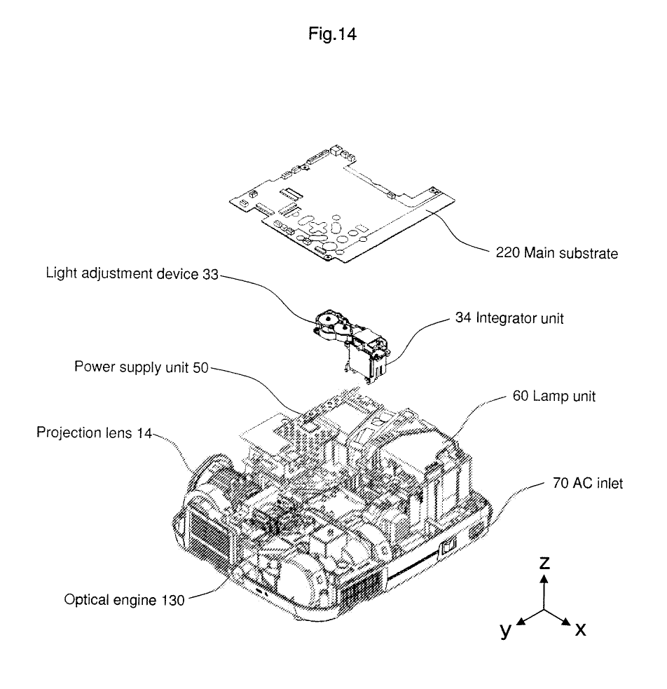

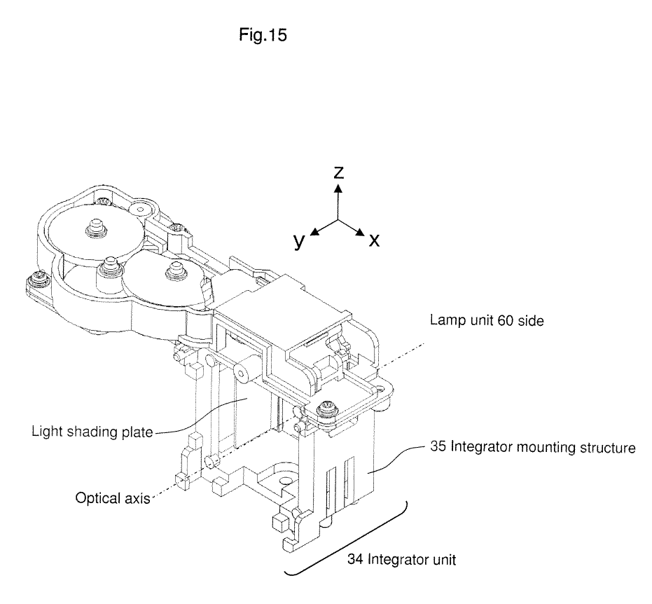

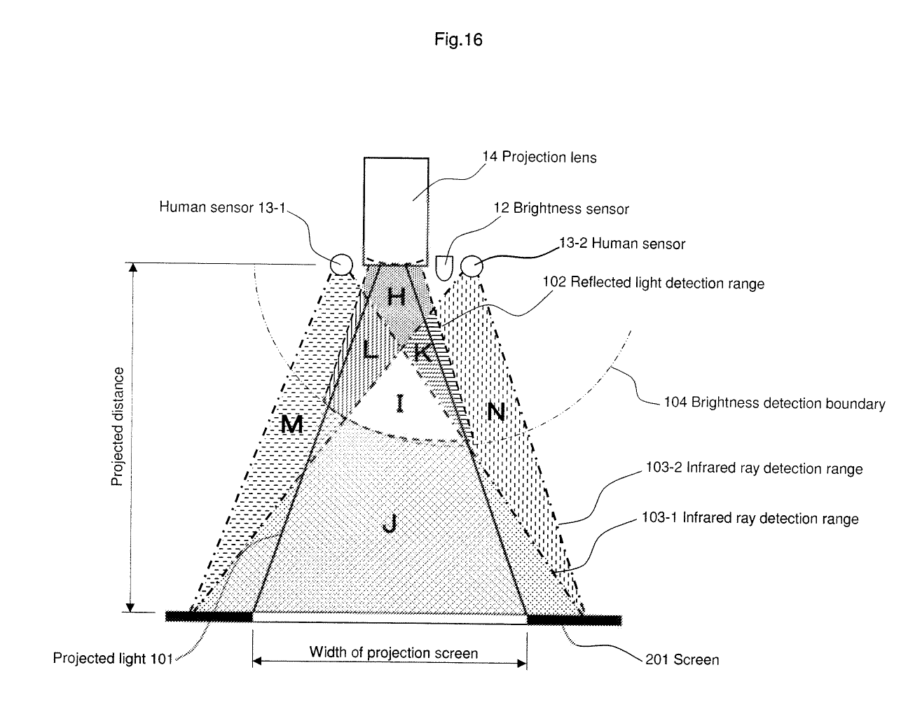

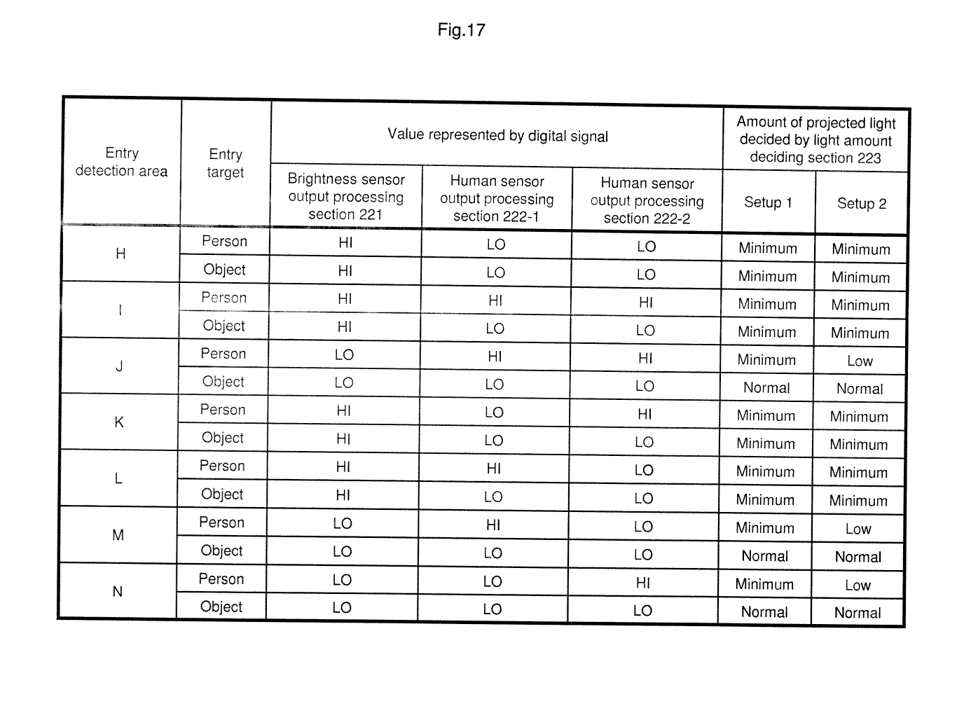

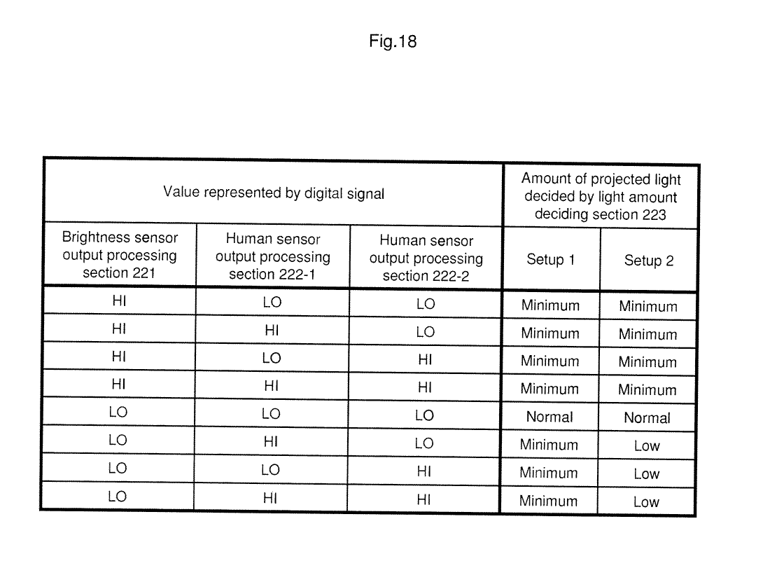

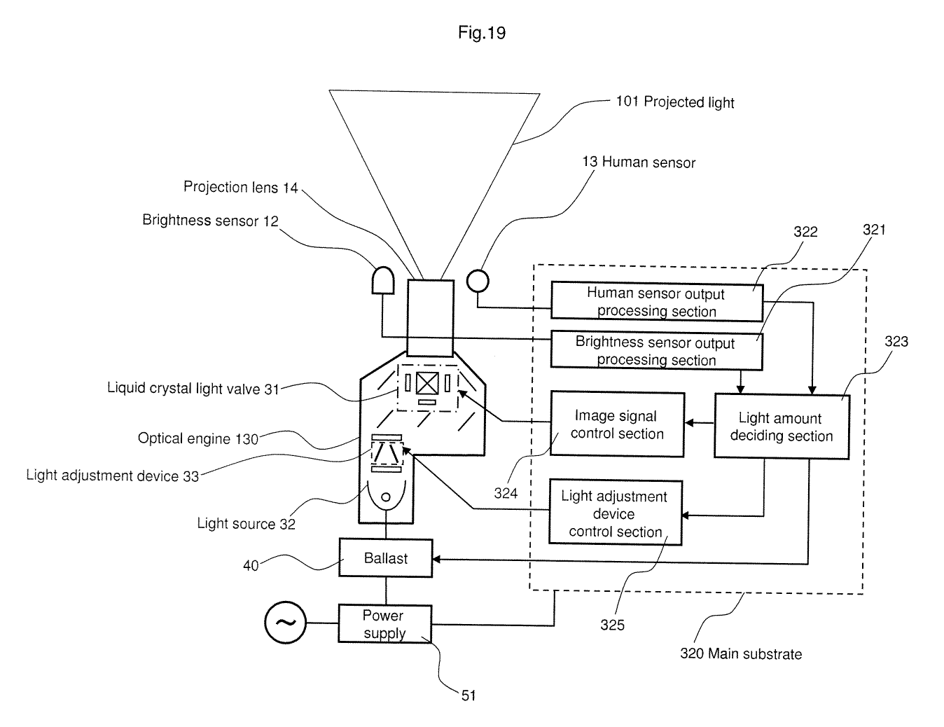

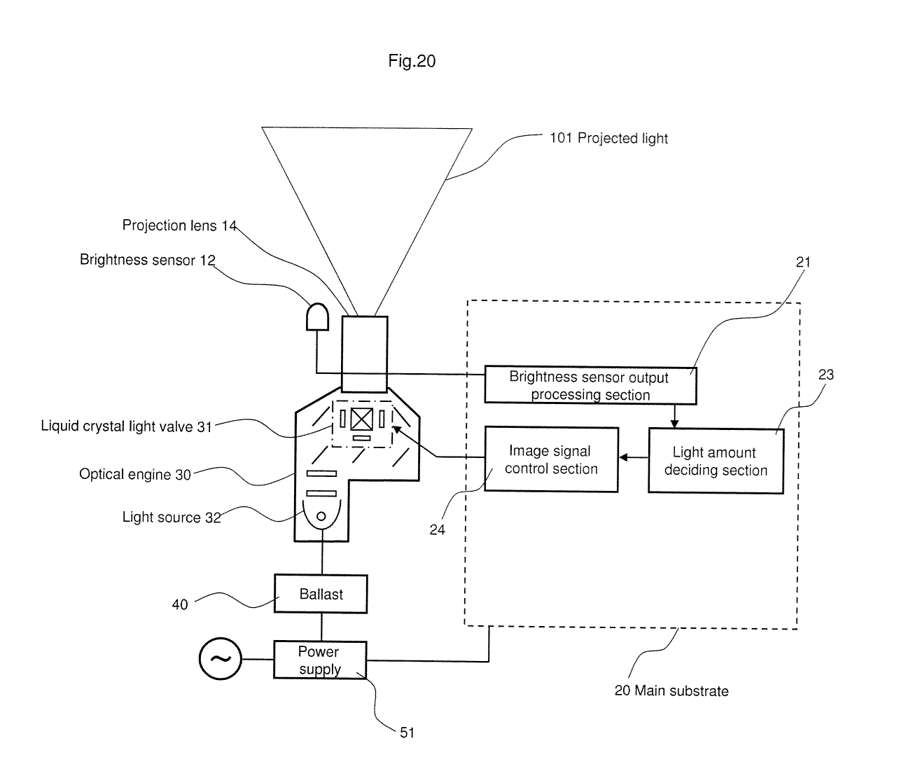

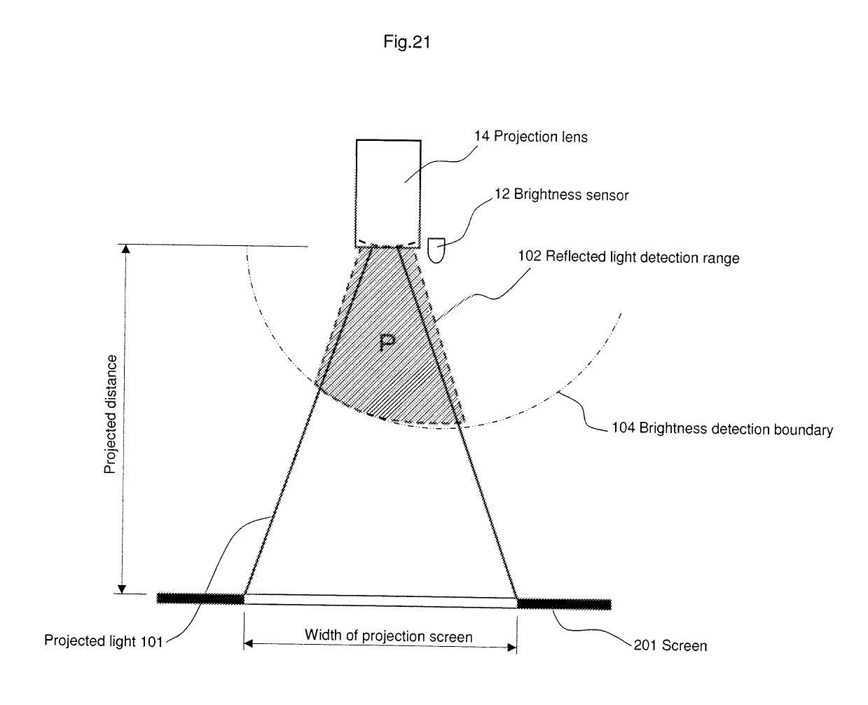

### BRIEF DESCRIPTION OF DRAWINGS

[FIG. 1] is a perspective view showing an appearance of a first embodiment of a projection type display device according to the present invention.

[FIG. 2] is a block diagram showing an example of the structure of the projection type display device shown in FIG. 1.

[FIG. 3] is a schematic diagram showing an example of detection ranges of a brightness sensor and a human sensor shown in FIG. 1 and FIG. 2.

[FIG. 4] is a schematic diagram showing an example of the relationship between a combination of values represented by digital signals that are output from a brightness sensor output processing section and a human sensor output processing section shown in FIG. 2 and the amount of projected light decided by the light amount deciding section shown in FIG. 2.

[FIG. 5] is a schematic diagram showing an example of a setup screen of the projection type display device, the setup screen being displayed on a target to be projected by the projection type display device shown in FIG. 1 and FIG. 2.

[FIG. 6] is a flow chart describing an operation of the projection type display device shown in FIG. 1 to FIG. 5 that decides the amount of projected light.

[FIG. 7] is a schematic diagram describing detection ranges of the brightness sensor and the human sensor shown in FIG. 1 and FIG. 2.

[FIG. 8] is a schematic diagram showing an example of the relationship between values represented by digital signals that are output from the brightness sensor output processing section and the human sensor output processing section and the amount of projected light decided by the light amount deciding section when a person or an object enters entry detection areas shown in FIG. 7.

[FIG. 9] is a block diagram showing the structure of a second embodiment of the projection type display device according to the present invention.

[FIG. 10] is a schematic diagram describing detection ranges of the brightness sensor and the human sensor shown in FIG. 9.

[FIG. 11] is a schematic diagram showing an example of the relationship between values represented by digital signals that are output from the brightness sensor output processing section and the human sensor output processing section and the amount of projected light decided by the light amount deciding section when a person or an object enters entry detection areas shown in FIG. 10.

[FIG. 12] is a schematic diagram showing an example of the relationship between values represented by digital signals that are output from the brightness sensor output processing section and the human sensor output processing section shown in FIG. 9 and the amount of projected light decided by the light amount deciding section shown in FIG. 9.

[FIG. 13] is a block diagram showing the structure of a third embodiment of the projection type display device according to the present invention.

[FIG. 14] is a perspective view showing that a light adjustment device has been removed fro the projection type display device shown in FIG. 13.

[FIG. 15] is an enlarged perspective view of the light adjustment device shown in FIG. 14.

[FIG. 16] is a schematic diagram describing detection ranges of the brightness sensor and the human sensor shown in FIG. 13.

[FIG. 17] is a schematic diagram showing an example of the relationship between values represented by digital signals that are output from the brightness sensor output processing section and the human sensor output processing section and the amount of projected light decided by the light amount deciding section when a person or an object enters entry detection areas shown in FIG. 16.

[FIG. 18] is a schematic diagram showing an example of the relationship between values represented by digital signals that are output from the brightness sensor output processing section and the human sensor output processing section shown in FIG. 13 and the amount of projected light decided by the light amount deciding section shown in FIG. 13.

[FIG. 19] is a block diagram showing the structure of a fourth embodiment of the projection type display device according to the present invention.

[FIG. 20] is a block diagram showing the structure of a fifth embodiment of the projection type display device according to the present invention.

[FIG. 21] is a schematic diagram describing the detection range of a brightness sensor shown in FIG. 20.

### BEST MODES THAT CARRY OUT THE INVENTION

Next, with reference to drawings, embodiments of the present invention will be described.

### First Embodiment

FIG. 1 is a perspective view showing an appearance of a first embodiment of a projection type display device according to the present invention. The projection type display device according to this embodiment is of three-panel liquid crystal type.

Provided in main body case 11 are an optical engine having a light source and an image generation device; an optical system module having members including projection lens 14; a ballast that causes the light source to emit light; a main substrate having an IO (Input Output) terminal through which audio and image signals are input from and output to the outside; a power supply that supplies power to these electric members; and a cooling fan that cools these heat generation members. The light source is an ultra-high voltage mercury lamp that emits light based on discharging between electrodes, whereas the image generation device is a liquid crystal light valve (liquid crystal panel).

In the projection type display device according to this embodiment, an image generated by the image generation device provided in the optical engine is enlarged and displayed on a target to be projected, such as a screen, with projected light of which light emitted by the light source is projected through projection lens 14.

Brightness sensor 12 that operates as a first sensor and human sensor 13 that operates as a second sensor are arranged on opposite sides with respect to projection lens 14, namely symmetrical with respect to the optical axis of the projected light.

FIG. 2 is a block diagram showing an example of the structure of the projection type display device shown in FIG. 1.

As shown in FIG. 2, the projection type display device shown in FIG. 1 is provided with brightness sensor 12; human sensor 13; projection lens 14; main substrate 20; optical engine 30 having liquid crystal light valve 31 and light source 32; ballast 40; and power supply 51.

Brightness sensor 12 is for example a photo diode. A photo diode is a typical optical sensor that converts light energy into electric energy and that is small in size and light in weight and has high response characteristics. When light enters a photo diode, since a current proportional to the amount of light that enters flows in the photo diode, a voltage corresponding to the amount of light can be obtained by a current—voltage conversion circuit that uses an operational amplifier. When a person or an object approaches the neighborhood of projection lens 14, the projected light is reflected on the surface of the person or object. The reflected light enters brightness sensor 12. Brightness sensor 12 detects the reflected light and outputs a current corresponding to the amount of reflected light.

Here, the relationship between the amount of projected light and the amount of reflected light detected when a person or an object approaches the neighborhood of projection lens 14 will be described.

When a person or an object approaches the neighborhood of projection lens 14 and the projected image is bright, namely the amount of projected light is large, the amount of reflected light detected by brightness sensor 12 becomes large. In this case, the amount of projected light can be adjusted so that it decreases. In contrast, when the projected light is dark, namely the amount of projected light is small, the amount of reflected light detected by brightness sensor 12 becomes small. In this case, the amount of projected light does not need to be adjusted.

Generally, a distance sensor is used to detect whether a person or an object approaches the projection lens and then whether or not it is necessary to adjust the amount of projected light is decided based on a combination of information that represents the distance measured by the distance sensor and the amount of projected light. In other words, it takes a considerable amount of time to adjust the amount of projected light. In contrast, according to this embodiment, whether or not it is necessary to adjust the amount of projected light can be instantaneously determined by using brightness sensor 12.

Human sensor 13 is, for example, a pyroelectric infrared sensor. A pyroelectric infrared sensor uses the pyroelectric effect of a ferroelectric ceramic. When a pyroelectric infrared sensor is used, a voltage corresponding to the amount of change of an infrared ray emitted from the human body or the like can be obtained. Human sensor 13 outputs such a voltage. Generally, an optical lens such as a Fresnel lens is arranged immediately in front of a element section (not shown) of the pyroelectric infrared sensor such that the detection range of an infrared ray lies in a desired range. According to this embodiment, a detection range is accomplished nearly in a quadrangular pyramid shape in the direction of the optical path of the projected light by a combination of optical elements corresponding to the element section.

When a CCD camera is used, it becomes difficult to select a person from a projected image and a target to be projected. However, since the main component of projected light of the projection type display device is visible light, when a pyroelectric infrared sensor is used as presented in this embodiment, without it being necessary to make such a selection, a person can be instantaneously detected.

FIG. 3 is a schematic diagram showing an example of detection ranges of brightness sensor 12 and human sensor 13 shown in FIG. 1 and FIG. 2. Projected light 101 denoted by a solid line represents projected light projected from the projection type display device. On the other hand, reflected light detection range 102 denoted by a dashed line represents a range in which brightness sensor 12 detects reflected light of the projected light which is reflected by a person or an object. On the other hand, infrared ray detection range 103 denoted by a dash-dotted line represents an infrared ray detection range of human sensor 13. Although both reflected light detection range 102 and infrared ray detection range 103 are formed nearly in a quadrangular pyramid shape, the drawing shows only diagonal ridgelines for ease of understanding.

With reference to FIG. 2 again, main substrate 20 is provided with brightness sensor output processing section 21 that operates as a first signal generation section; human sensor output processing section 22 that operates as a second signal generation section; light amount deciding section 23; and image signal control section 24.

Brightness sensor output processing section 21 is connected to brightness sensor 12 and is provided with a current—voltage conversion circuit using an operational amplifier; and a comparator. Brightness sensor output processing section 21 accepts an input of a current that is output from brightness sensor 12. This current is a current corresponding to the amount of light that enters the photo diode of brightness sensor 12. Thereafter, brightness sensor output processing section 21 converts the accepted current into a corresponding voltage and performs a threshold process that compares the converted voltage with a predetermined voltage value so as to generate a digital signal that is a first signal having one of two values of a high level (5 V) and a low level (0 V). Thereafter, brightness sensor output processing section 21 outputs the generated digital signal to light amount deciding section 23. Hereinafter, the high level is denoted by HI, whereas the low level is denoted by LO.

Human sensor output processing section 22 is connected to human sensor 13 and is provided with two stages of amplification circuits that use operational amplifiers; and a comparator. Human sensor output processing section 22 accepts an input of a voltage that is output from human sensor 13. This voltage is a voltage corresponding to the amount of change of an infrared ray detected by the pyroelectric infrared sensor of human sensor 13. Thereafter, human sensor output processing section 22 amplifies the accepted voltage and performs a threshold process that compares the amplified voltage with a predetermined voltage value so as to generate a digital signal that is a second signal having one of values of HI (5 V) and LO (0 V). Thereafter, human sensor output processing section 22 outputs the generated digital signal to light amount deciding section 23.

Light amount deciding section 23 is composed of a digital signal processing circuit having a data storage circuit and accepts inputs of the digital signals having one of values of HI and LO that are output from brightness sensor output processing section 21 and human sensor output processing section 22. Thereafter, light amount deciding section 23 performs a software process that decides the amount of projected light based on a combination of the values represented by these input digital signals. Thereafter, light amount deciding section 23 outputs information that represents the decided amount of projected light to image signal control section 24. When light amount deciding section 23 decides the amount of projected light, light amount deciding section 23 selects as the amount of light for example one from among “normal,” “low,” and “minimum” that is a first amount of light. This operation will be described later in detail.

In this embodiment, the amount of projected light is adjusted by controlling the gradation of the image signal. Image signal control section 24 drives liquid crystal light valve 31 based on information that is output from light amount deciding section 23 so as to control the gradation of the image signal. As a result, the amount of projected light is adjusted.

Liquid crystal light valve 31 is a light transmission type liquid crystal panel arranged for each of optical paths of R (Red), G ((Green), and B (Blue) and is controlled in 256 gradation levels based on a digital value ranging from 0 to 255 that is output from image signal control section 24.

FIG. 4 is a schematic diagram showing an example of the relationship between a combination of values represented by digital signals that are output from brightness sensor output processing section 21 and human sensor output processing section 22 shown in FIG. 2 and the amount of projected light decided by light amount deciding section 23 shown in FIG. 2. FIG. 5 is a schematic diagram showing an example of a setup screen of the projection type display device displayed on a target to be projected by the projection type display device shown in FIG. 1 and FIG. 2.

In FIG. 5, setup 1 and setup 2 are modes to adjust the amount of projected light. The user of the projection type display device can freely select and set up a mode by operating key button 15 (refer to FIG. 1) while observing the setup screen shown in FIG. 5. On the setup screen shown in FIG. 5, “setup 1” has been selected. “Function disabled” shown in FIG. 5 is a setup mode that disables the function that detects a person and an object.

The amount of projected light decided by light amount deciding section 23 is one from among three types: “normal,” “low,” and “minimum” as shown in FIG. 4. “Normal” represents the state of a source signal in which the gradation of the image signal is not changed; “low” represents the state in which the gradation of the source signal is decreased to, for example, ⅓; and “minimum” represents the state in which the gradation of the source signal is decreased more than that is in “low,” for example, a light shading state.

In “setup 1”, for example as shown in FIG. 4, when the value represented by the digital signal that is output from brightness sensor output processing section 21 is HI and the value represented by the digital signal that is output from human sensor output processing section 22 is also HI, light amount deciding section 23 decides that the amount of projected light will be “minimum.” On the other hand, when the value represented by the digital signal that is output from brightness sensor output processing section 21 is LO and the value represented by the digital signal that is output from human sensor output processing section 22 is also LO, light amount deciding section 23 decides that the amount of projected light will be “normal.”

In contrast, in “setup 2,” when the value represented by the digital signal that is output from brightness sensor output processing section 21 is HI and the value represented by the digital signal that is output from human sensor output processing section 22 is also HI, light amount deciding section 23 decides that the amount of projected light will be “low.”

Next, an operation of the projection type display device having the foregoing structure that decides the amount of projected light will be described.

FIG. 6 is a flow chart describing an operation of the projection type display device shown in FIG. 1 to FIG. 5 that decides the amount of projected light.

After the power supply of the projection type display device is turned on, the amount of projected light is set to “normal” as an initial value (at step S1). Thereafter, light source 32 starts emitting light.

Around 30 seconds after light source 32 starts emitting light, light amount deciding section 23 refers to the values represented by the digital signals that are output from brightness sensor output processing section 21 and human sensor output processing section 22 (at step S2). In this example, 30 seconds is an approximate period of time necessary to allow light source 32 to stably and brightly emit light.

Here, it is determined whether or not the OFF button has been pressed to turn off the power of the projection type display device (at step S3).

When the determination result at step S3 denotes that the OFF button has been pressed, the process of the operation is completed. In contrast, when the determined result at step S3 denotes that the OFF button has not been pressed, light amount deciding section 23 decides the amount of projected light based on the combination of the values represented by the two digital signals that light amount deciding section 23 has referred to at step S2 (at step S4). The method in which light amount deciding section 23 decides the amount of projected light is performed as described above with reference to FIG. 4.

Thereafter, light amount deciding section 23 determines whether or not the amount of projected light has been changed from “normal” (at step S5).

When the determined result at step S5 denotes that the amount of projected light has not been changed from “normal,” the flow returns to the operation at step S2 and thereby light amount deciding section 23 refers to the values represented by the digital signals that are output from brightness sensor output processing section 21 and human sensor output processing section 22 once again. The operation from steps S2 to S5 is performed at a very high speed. Specifically, the time interval after light amount deciding section 23 refers to the values represented by the digital signals until it refers to them again is around 30 ms. In contrast, when the determined result at step S5 denotes that the amount of projected light has been changed from “normal” to “low” or “minimum,” light amount deciding section 23 outputs information that denotes that the amount of projected light is “low” or “minimum” to image signal control section 24.

When the accepted information that is output from light amount deciding section 23 represents “low,” image signal control section 24 drives liquid crystal light valve 31 such that the gradation of the source signal is decreased to ⅓. On the other hand, when the accepted information represents “minimum,” image signal control section 24 drives liquid crystal light valve 31 such that the gradation of the source signal becomes, for example, the light shading state. Once the gradation of the image signal is changed, the state is kept unchanged until 10 seconds elapse so as to prevent the gradation from being frequently changed.

Ten seconds after the gradation of the image signal is changed, light amount deciding section 23 refers to the value represented by the digital signal that is output from human sensor output processing section 22 (at step S6).

Thereafter, light amount deciding section 23 determines the value represented by the digital signal that is output from human sensor output processing section 22 (at step S7).

When the determined result at step S7 denotes that the value represented by the digital signal that is output from human sensor output processing section 22 is LO, light amount deciding section 23 changes the amount of projected light to “normal” (at step S8) and then the flow advances to the operation at step S2. In contrast, when the determined result at step S7 denotes that the value represented by the digital signal that is output from human sensor output processing section 22 is HI, the flow advances to the operation at step S6. Thereafter, light amount deciding section 23 repeats the operation from steps S6 and S7 until the value represented by the digital signal that is output from human sensor output processing section 22 becomes LO. The time interval of this operation is approximately 30 ms like the operation from step S2 to S5. By repeating these steps of the operation, the amount of projected light can be quickly adjusted when a person or an object enters the projection area. After confirming that no person is present in the detection range, the amount of projected light can be securely restored to “normal.”

Next, the relationship between a combination of the values represented by the digital signals that are output from brightness sensor output processing section 21 and human sensor output processing section 22 and the amount of projected light when a person or an object enters the detection ranges of brightness sensor 12 and human sensor 13 will be described.

FIG. 7 is a schematic diagram describing the detection ranges of brightness sensor 12 and human sensor 13 shown in FIGS. 1 and 2. FIG. 7 is also a top view showing the projection type display device according to this embodiment.

In FIG. 7, projected light 101 denoted by a solid line represents projected light projected from the projection type display device. On the other hand, reflected light detection range 102 denoted by a dashed line represents a range in which brightness sensor 12 detects reflected light of the projected light which is reflected by a person or an object. On the other hand, infrared ray detection range 103 denoted by a dash-dotted line represents an infrared ray detection range of human sensor 13.

Brightness sensor 12 can detect light that is present inside brightness detection boundary 104 denoted by a dashed and double-dotted line, namely light in the detection range of brightness sensor 12. In other words, when projected light is reflected inside brightness detection boundary 104, the value represented by the digital signal that is output from brightness sensor output processing section 21 becomes HI.

The shape inside brightness detection boundary 104 is nearly a spherical shape with the center of an element section of brightness sensor 12 denoted by a dashed and double-dotted line shown in FIG. 7. However, brightness sensor 12 detects reflected light of projected light 101 which is reflected by a person or an object. Thus, reflected light detection range 102 lies in the range denoted by a dashed line.

On the other hand, human sensor 13 detects an infrared ray that does not directly relate to projected light 101 whose main component is visible light. Thus, human sensor 13 detects an infrared ray on projection screen 100 as the detection range in the projection direction. The optical lens arranged immediately in front of the element section of human sensor 13 causes the upper, lower, left, and right detection ranges perpendicular to the light path of projected light to have directivity such that the detection ranges cover entire projection screen 100 (wide zoom end). Alternatively, a light shading plate having a square opening may be used instead of the optical lens arranged according to this embodiment.

A plurality of areas denoted by alphabetic letters shown in FIG. 7 represent a projection area and its neighborhood areas where reflected light detection range 102, infrared ray detection range 103, and brightness detection boundary 104 overlap with each other. Hereinafter, these areas are referred to as entry detection areas.

FIG. 8 is a schematic diagram showing an example of the relationship between values represented by digital signals that are output from brightness sensor output processing section 21 and human sensor output processing section 22 and the amount of projected light decided by light amount deciding section 23 when a person or an object enters the entry detection areas shown in FIG. 7.

In “setup 1,” for example, when a person or an object enters entry detection area A, the value represented by the digital signal that is output from brightness sensor output processing section 21 becomes HI and the value represented by the digital signal that is output from human sensor output processing section 22 becomes LO. In this case, the amount of projected light is decided to be “minimum.” On the other hand, when an object enters entry detection area C, the value represented by the digital signal that is output from brightness sensor output processing section 21 becomes LO and the value represented by the digital signal that is output from human sensor output processing section 22 also becomes LO. In this case, it is decided that the amount of projected light will be “normal.”

In contrast, in “setup 2,” when a person enters entry detection area B, the value represented by the digital signal that is output from brightness sensor output processing section 21 becomes HI and the value represented by the digital signal that is output from human sensor output processing section 22 also becomes HI. In this case, it is decided that the amount of projected light will be “low.” On the other hand, when an object enters entry detection area C, the value represented by the digital signal that is output from brightness sensor output processing section 21 becomes LO and the value represented by the digital signal that is output from human sensor output processing section 22 also becomes LO. In this case, it is decided that the amount of projected light will be “normal.”

Except for an object that enters entry detection area C, setup 1 is a human eye care setup mode in which the amount of projected light is “minimum” and is sensitive to a person and an object that enter the projection area. On the other hand, in setup 2, even if a person enters entry detection area C, the amount of projected light remains “normal,” and even if a person enters entry detection area B, the amount of projected light is changed to “low”, not “minimum.” Setup 1 is a mode provided, for example, for an educational situation in which there are many children around the projection type display device, whereas setup 2 is a mode provided, for example, for a business situation in which an adult gives a presentation in front of a screen. Since the desired mode can be selected from a plurality of modes and the selected mode can be set up, the amount of projected light can be adjusted to correspond to various situations. This benefit can be applied to second to fifth embodiments that will be described later.

When a person enters an area in which the amount of projected light is small and therefore does not need to be further decreased, the amount of reflected light detected by brightness sensor 12 becomes small, whereas the amount of change of an infrared ray detected by human sensor 13 becomes large. In this case, in the foregoing “setup 2,” the projection type display device does not decrease the amount of projected light.

In contrast, when a person or an object enters an area in which the amount of projected light is large and thereby needs to be decreased, the amount of reflected light detected by brightness sensor 12 becomes large. In this case, in the foregoing “setup 2,” the projection type display device decreases the amount of projected light.

Thus, the amount of projected light can be quickly, adequately, and inexpensively adjusted corresponding to an object and an area in which it is present.

### Second Embodiment

The structure of this embodiment is different from that of the foregoing first embodiment in that the value represented by the digital signal that is output from a brightness sensor output processing section has three levels (high level, middle level, and low level) and in that the amount of projected light is adjusted by controlling power supplied to a light source. In the following, the value of the middle level of a digital signal is denoted by MD.

FIG. 9 is a block diagram showing the structure of a second embodiment of the projection type display device according to the present invention.

As shown in FIG. 9, a projection type display device according to this embodiment is provided with main substrate 120; optical engine 30 having liquid crystal light valve 31 and light source 32; ballast 40; and power supply 51.

Main substrate 120 is provided with brightness sensor output processing section 121 that operates as a first signal generation section; human sensor output processing section 122 that operates as a second signal generation section; light amount deciding section 123; and image signal control section 124.

Brightness sensor output processing section 121 is connected to brightness sensor 12 and is provided with a current—voltage conversion circuit using an operational amplifier; and a comparator. Brightness sensor output processing section 121 accepts an input of a current that is output from brightness sensor 12. Thereafter, brightness sensor output processing section 121 converts the accepted current into a corresponding voltage and performs a threshold process that compares the converted voltage with a predetermined voltage value so as to generate a digital signal that is a first signal that has one of three values of HI (5 V), MD (2.5 V), and LO (0 V). Thereafter, brightness sensor output processing section 121 outputs the generated digital signal to light amount deciding section 123.

Since the structure of human sensor output processing section 122 is the same as that of human sensor output processing section 22 described in the first embodiment, description will be omitted.

The structure of light amount deciding section 123 is the same as that of light amount deciding section 23 described in the first embodiment except for a software process based on an accepted digital signal. Light amount deciding section 123 decides the amount of projected light corresponding to a combination of the values represented by the digital signals that are output from brightness sensor output processing section 121 and human sensor output processing section 122. Thereafter, light amount deciding section 123 outputs a digital signal that represents the decided amount of projected light to ballast 40 that is a power supply section for a lamp of light source 32.

Ballast 40 controls the output of the lamp of light source 32 in eight levels corresponding to a digital signal that represents one from among 0 to 7 and that is output from light amount deciding section 23. Thus, the amount of projected light is adjusted. In this embodiment, it is assumed that the output value of the lamp of light source 32 is 300 W.

FIG. 10 is a schematic diagram describing detection ranges of brightness sensor 12 and human sensor 13 shown in FIG. 9. FIG. 10 is also a schematic diagram that corresponds to FIG. 7 described in the first embodiment.

In FIG. 10, projected light 101 denoted by a solid line represents projected light projected from the projection type display device. On the other hand, reflected light detection range 102 denoted by a dashed line represents a range in which brightness sensor 12 detects reflected light of the projected light which is reflected by a person or an object. On the other hand, infrared ray detection range 103 denoted by a dash-dotted line represents an infrared ray detection range of human sensor 13.

Brightness sensor 12 can detect light inside brightness detection boundary 104-1 denoted by a dashed and double-dotted line, namely light in the detection range of brightness sensor 12. When projected light is reflected in the range from brightness detection boundary 104-1 to brightness detection boundary 104-2, the value represented by the digital signal that is output from brightness sensor output processing section 121 becomes MD. On the other hand, when projected light is reflected inside brightness detection boundary 104-2, the value represented by the digital signal that is output from brightness sensor output processing section 121 becomes HI.

Like FIG. 7, a plurality of areas denoted by alphabetic letters shown in FIG. 10 represent entry detection areas.

FIG. 11 is a schematic diagram showing an example of the relationship between values represented by digital signals that are output from brightness sensor output processing section 121 and human sensor output processing section 122 and the amount of projected light decided by light amount deciding section 123 when a person or an object enters the entry detection areas shown in FIG. 7.

The amount of projected light decided by light amount deciding section 123 has three types as shown in FIG. 11: “normal,” “low,” and “minimum” that is a second amount of light. “Normal” is a state in which the output value of the lamp of light source 32 is 300 W. “Minimum” is a state in which the output value of the lamp of light source 32 is 240 W (80% of the normal amount of light) that is the lowest brightness of the lamp. “Low” is a state in which the output value of the lamp of light source 32 is 266 W that is four levels lower than the “normal” state of 300 W. These output values of the lamp are just examples and thereby this embodiment is not limited thereto.

In “setup 1,” for example, when a person or an object enters entry detection area D, the value represented by the digital signal that is output from brightness sensor output processing section 121 becomes HI and the value represented by the digital signal that is output from human sensor output processing section 122 becomes LO. In this case, the amount of projected light is decided to be “minimum.” On the other hand, when an object enters entry detection area F, the value represented by the digital signal that is output from brightness sensor output processing section 121 becomes LO and the value represented by the digital signal that is output from human sensor output processing section 122 also becomes LO. In this case, the amount of projected light is decided to be “normal.” On the other hand, when an object enters entry detection area E, the value represented by the digital signal that is output from brightness sensor output processing section 121 becomes MD and the value represented by the digital signal that is output from human sensor output processing section 122 becomes LO. In this case, the amount of projected light is decided to be “minimum.” On the other hand, when a person or an object enters entry detection area G, the value represented by the digital signal that is output from brightness sensor output processing section 121 becomes MD and the value represented by the digital signal that is output from human sensor output processing section 122 becomes LO. In this case, it is decided that the amount of projected light will be “minimum.”

In contrast, in “setup 2,” when an object enters entry detection area E, the value represented by the digital signal that is output from brightness sensor output processing section 121 becomes MD and the value represented by the digital signal that is output from human sensor output processing section 122 becomes LO. In this case, it is decided that the amount of projected light will be “low.” On the other hand, when a person or an object enters entry detection area G, the value represented by the digital signal that is output from brightness sensor output processing section 121 becomes MD and the value represented by the digital signal that is output from human sensor output processing section 122 becomes LO. In this case, it is decided that the amount of projected light will be “low.”

FIG. 12 is a schematic diagram showing an example of the relationship between values represented by digital signals that are output from brightness sensor output processing section 121 and human sensor output processing section 122 shown in FIG. 9 and the amount of projected light decided by light amount deciding section 123 shown in FIG. 9. FIG. 12 shows an extraction of the relationship shown in FIG. 11 based only on the values represented by digital signals that are output from brightness sensor output processing section 121 and human sensor output processing section 122 and the amount of projected light decided by light amount deciding section 123.

The value represented by the digital signal that is output from brightness sensor output processing section 121 is one of three values: HI, MD, or LO, whereas the value represented by the digital signal that is output from human sensor output processing section 122 is one of two values: HI or LO. Thus, as shown in FIG. 12, the number of combinations of the values represented by digital signals is a total of six.

Thus, the amount of projected light in setup 1 according to this embodiment is the same as that according to the first embodiment. However, the case that the amount of projected light becomes “low” (decreased to ⅓ of source signal) can be increased in setup 2 in comparison with the first embodiment. As a result, the amount of projected light can be more precisely adjusted than in the foregoing embodiment.

### Third Embodiment

The structure of this embodiment is different from that of the foregoing first embodiment n that two human sensors are arranged on opposite sides with respect to projection lens 14 and in that a light adjustment device (diaphragm) of the light shading type is provided in an optical engine and the amount of projected light is adjusted by controlling the light adjustment device.

FIG. 13 is a block diagram showing the structure of a third embodiment of the projection type display device according to the present invention.

The projection type display device according to this embodiment is provided with main substrate 220; optical engine 130 having liquid crystal light valve 31, light source 32, and light adjustment device 33; ballast 40; and power supply 51.

Main substrate 220 is provided with brightness sensor output processing section 221 that operates as a first signal generation section; human sensor output processing sections 222-1 and 222-2 that operate as second signal generation sections; light amount deciding section 223; image signal control section 224; and light adjustment device control section 225. Human sensor output processing section 222-1 is connected to human sensor 13-1, whereas human sensor output processing section 222-2 is connected to human sensor 13-2.

Since the structure of brightness sensor output processing section 221 is the same as that of brightness sensor output processing section 21 described in the first embodiment and since the structure of each of human sensor output processing sections 222-1 and 222-2 is the same as that of human sensor output processing section 22 described in the first embodiment, their description will be omitted.

The structure of light amount deciding section 223 is the same as that of light amount deciding section 23 described in the first embodiment except for a software process based on an accepted digital signal. Light amount deciding section 223 decides the amount of projected light corresponding to a combination of the values represented by the digital signals that are output from brightness sensor output processing section 221 and human sensor output processing sections 222-1 and 222-2. Thereafter, light amount deciding section 223 outputs a digital signal that represents the decided amount of projected light to light adjustment device control section 225.

Light adjustment device control section 225 controls light adjustment device 33 based on a digital signal that is output from light amount deciding section 223. As a result, the amount of projected light is adjusted. The digital signal that is output from light amount deciding section 223 has one of 256 values from 0 to 255 and thereby light adjustment device 33 is controlled in 256 levels.

Here, the structure of light adjustment device 33 will be described.

FIG. 14 is a perspective view showing that light adjustment device 33 has been removed from the projection type display device shown in FIG. 13. As shown in FIG. 14, light adjustment device 33 is provided in integrator unit 34 that partly constructs optical engine 130 and adjusts light by shading the optical path of light emitted from a lamp provided in lamp unit 60 with a rotary light shading plate.

FIG. 15 is an enlarged perspective view of light adjustment device 33 shown in FIG. 14.

In light adjustment device 33 shown in FIG. 15, a stepping motor (not shown) whose rotation is controlled is decelerated by a plurality of gears and the light shading plate is opened and closed by two mechanical driving systems incorporated with an upper portion of the light shading plate having a rotation axis in the Z direction. Even if the light shading plate is fully closed, the center portion has a slight opening and thereby 10% of light is not shaded, but emitted.

FIG. 16 is a schematic diagram describing detection ranges of brightness sensor 12 and human sensors 13-1 and 13-2 shown in FIG. 13. FIG. 16 is also a schematic diagram corresponding to FIG. 7 described in the first embodiment.

In FIG. 16, projected light 101 denoted by a solid line represents projected light projected from the projection type display device. On the other hand, reflected light detection range 102 denoted by a dashed line represents a range in which brightness sensor 12 detects reflected light of the projected light which is reflected by a person or an object. On the other hand, infrared ray detection ranges 103-1 and 103-2 denoted by dash-dotted lines represent infrared ray detection ranges of human sensors 13-1 and 13-2, respectively.

Brightness sensor 12 can detect light that is present inside brightness detection boundary 104 denoted by a dashed and double-dotted line, namely light in the detection range of brightness sensor 12. When projected light is reflected inside brightness detection boundary 104, the value represented by the digital signal that is output from brightness sensor output processing section 221 becomes HI.

Like FIG. 7, a plurality of areas denoted by alphabetic letters shown in FIG. 16 represent entry detection areas.

FIG. 17 is a schematic diagram showing an example of the relationship between values represented by digital signals that are output from brightness sensor output processing section 221 and human sensor output processing sections 222-1 and 222-2 and the amount of projected light decided by light amount deciding section 223 when a person or an object enters the entry detection areas shown in FIG. 17.

The amount of projected light decided by light amount deciding section 223 is one of three types: “normal,” “low,” and “minimum” as shown in FIG. 17. “Normal” represents a state in which light adjustment device 33 is not operated; “minimum” represents a state in which light adjustment device 33 is operated and the optical path is closed by the light shading plate (10% of normal amount of light); and “low” represents a state in which light adjustment device 33 is operated such that the optical path is closed by the light shading plate for 70% (50% of the normal amount of light).

In “setup 1,” for example, when a person or an object enters entry detection area H shown in FIG. 16, the value represented by the digital signal that is output from brightness sensor output processing section 221 becomes HI, the value represented by the digital signal that is output from human sensor output processing section 222-1 becomes LO, and the value represented by the digital signal that is output from human sensor output processing section 222-2 also becomes LO. In this case, it is decided that the amount of projected light will be “minimum.” On the other hand, when a person enters entry detection area J, the value represented by the digital signal that is output from brightness sensor output processing section 221 becomes LO, the value represented by the digital signal that is output from human sensor output processing section 222-1 becomes HI, and the value represented by the digital signal that is output from human sensor output processing section 222-2 also becomes HI. In this case, it is decided that the amount of projected light will be “minimum.” On the other hand, when a person enters entry detection area N, the value represented by the digital signal that is output from brightness sensor output processing section 221 becomes LO, the value represented by the digital signal that is output from human sensor output processing section 222-1 also becomes LO, and the value represented by the digital signal that is output from human sensor output processing section 222-2 becomes HI. In this case, it is decided that the amount of projected light will be “minimum.”

In contrast, in “setup 2,” when a person enters entry detection area J, the value represented by the digital signal that is output from brightness sensor output processing section 221 becomes LO, the value represented by the digital signal that is output from human sensor output processing section 222-1 becomes HI, and the value represented by the digital signal that is output from human sensor output processing section 222-2 also becomes HI. In this case, it is decided that the amount of projected light will be “low.” On the other hand, when a person enters entry detection area N, the value represented by the digital signal that is output from brightness sensor output processing section 221 becomes LO, the value represented by the digital signal that is output from human sensor output processing section 222-1 also becomes LO, and the value represented by the digital signal that is output from human sensor output processing section 222-2 becomes HI. In this case, it is decided that the amount of projected light will be “low.”

FIG. 18 is a schematic diagram showing an example of the relationship between values represented by digital signals that are output from brightness sensor output processing section 221 and human sensor output processing sections 222-1 and 222-2 shown in FIG. 13 and the amount of projected light decided by light amount deciding section 223 shown in FIG. 13. FIG. 18 shows an extraction of the relationship shown in FIG. 17 based only on the values represented by digital signals that are output from brightness sensor output processing section 221 and human sensor output processing sections 222-1 and 222-2 and the amount of projected light decided by light amount deciding section 223.

The value represented by the digital signal that is output from each of brightness sensor output processing section 221 and human sensor output processing sections 222-1 and 222-2 is one of two values: HI or LO. Thus, the number of combinations of the values represented by the digital signal is a total of eight as shown in FIG. 18.

According to this embodiment, since two human sensors are provided, the amount of projected light can be more accurately adjusted without it being necessary to have a structure that causes the digital signal that is output from the brightness sensor output processing section to have one of three values (HI, MD, and LO) like the second embodiment.

### Fourth Embodiment

This embodiment is provided with all means that adjust the amount of projected light described in the first to third embodiments.

FIG. 19 is a block diagram showing the structure of a fourth embodiment of the projection type display device according to the present invention.

As shown in FIG. 19, the projection type display device according to this embodiment is provided with main substrate 320; optical engine 130 having liquid crystal light valve 31, light source 32, and light adjustment device 33; ballast 40; and power supply 51.

Main substrate 320 is provided with brightness sensor output processing section 321 that operates as a first signal generation section; human sensor output processing section 322 that operates as a second signal generation section; light amount deciding section 323; image signal control section 324, and light adjustment device control section 325.

Image signal control section 324 drives liquid crystal light valve 31 so as to control the gradation of an image signal.

Light amount deciding section 323 controls ballast 40 so as to control the output value of a lamp of light source 32.

Light adjustment control section 325 operates light adjustment device 33 so as to control the light shading amount.

The foregoing three light amount adjustment means have characteristics according to which the adjustable ranges of operation speed and amount of projected light differ. Next, the operation that adjusts the amount of projected light will be described with an example in which the amount of projected light is decreased as much as possible, namely light amount deciding section 323 has decided that the amount of projected light will be “minimum.”

The means in which the gradation of an image signal is adjusted by controlling liquid crystal light valve 31 operates at the highest speed in the other means and causes a projected image to become black. However, since the projected image is not perfect black, and since a slight light is transmitted. the amount light becomes 0.2%. Although the means, in which the output value of the lamp of light source 32 is controlled by ballast 40, can operate at a higher speed, the lower limit of the amount of light is 80%. On the other hand, since the means, in which the light shading amount is controlled by light adjustment device 33, slowly operates because the light shading plate is mechanically rotated, the lower limit of the amount of light is 10%.

In other words, to decrease the amount of projected light as quickly and as much as possible, image signal control section 324 drives liquid crystal light valve 31 so as to adjust the gradation (0.2% of normal amount of light). Thereafter, light amount deciding section 323 controls ballast 40 so as to decrease the output value of the lamp of light source 32 and thereby to decrease the amount of light to 80% of the normal amount of light. Thus, as a synergy effect with the adjustment of the gradation of the image signal, the amount of light becomes 0.16% of the normal amount of light. Thereafter, light adjustment control section 325 operates light adjustment device 33 so as to decrease the amount of light to 10% of the normal amount of light. Thus, as a synergy effect with the adjustment of the gradation and the adjustment of the output value of the lamp of light source 32, the amount of light becomes 0.016% of the normal amount of light. As a result, when control of the output value of the lamp of light source 32 is caused to have precedence over the operation of light adjustment device 33, the temperature of light adjustment device 33 can be prevented from rising.

In such a manner, according to this embodiment, a plurality of means that adjust the amount of projected light are provided, they are assigned priority, and they are operated in the assigned priority. As a result, according to this embodiment, the amount of projected light can be adjusted at a higher speed than in other embodiments.

### Fifth Embodiment

FIG. 20 is a block diagram showing the structure of a fifth embodiment of the projection type display device according to the present invention.

Since the structure of this embodiment is the same as that of the first embodiment, except that human sensor 13 is removed from the structure of the first embodiment, the description of the structure of this embodiment will be omitted.

Since the output value of a lamp of light source 32 of the projection type display device according to this embodiment is as low as 200 W. the amount of projected light is large only in the neighborhood of projection lens 14. Thus, the amount of projected light does not need to be decreased depending on whether there is a person who is away from projection lens 14. In the following, the operation of the projection type display device according to this embodiment will be described.

FIG. 21 is a schematic diagram describing the detection range of a brightness sensor shown in FIG. 20. FIG. 21 is also a schematic diagram corresponding to FIG. 7 described in the first embodiment.

In FIG. 21, projected light 101 denoted by a solid line represents projected light projected from the projection type display device. Brightness sensor 12 can detect light inside brightness detection boundary 104 denoted by a dashed and double-dotted line, namely on the side of brightness sensor 12.

An area denoted by alphabetic letter P represents an entry detection area.

In FIG. 21, when a person or an object enters entry detection area P, the value represented by the digital signal that is output from brightness sensor 12 becomes HI. Thus, light amount deciding section 23 decides that the amount of projected light will be “minimum.” As a result, image signal control section 24 drives liquid crystal light valve 31 such that the amount of projected light becomes “minimum,” for example, it lies in the light shading state.

Although the means that adjusts the amount of projected light according to this embodiment drives liquid crystal light valve 31 so as to control the gradation of an image signal, the means may cause the ballast to control the output value of the lamp of light source 32 as in the second embodiment. Alternatively, the means may cause the light adjustment device control section to control the amount of projected light of the light adjustment device as in the third embodiment. Further alternatively, all means that adjust the amount of projected light may be used like the fourth embodiment.

In the foregoing first to fifth embodiments, by using the comparators provided in the brightness sensor output processing section and the human sensor output processing section, digital signals of HI (5 V), LO (0 V), or MD (2.5 V) were output to the light amount deciding section. Alternatively, the foregoing operation can be accomplished in such a manner that an analog signal is output to the light amount deciding section and the analog signal is converted into a corresponding digital signal which is then processed.

Moreover, according to the foregoing first to fifth embodiments, the light amount deciding section is composed of a digital signal processing circuit having a data storage circuit and decides by a software process the amount of projected light based on the digital signals that are output from the brightness sensor output processing section and the human sensor output processing section. Alternatively, the light amount deciding section can be composed of a logic circuit that uses an IC (Integrated Circuit) rather than a software process to decide the amount of projected light. In this case, as an effect of the alternative structure, the amount of projected light can be adjusted very quickly.

Although the projection type display devices according to the foregoing first to fifth embodiments were described as a three-panel liquid crystal type, the present invention can be realized by an optical engine using a reflection type device typified by a single-panel liquid crystal type device and a DMD (Digital Mirror Device). In addition, light source 32 may be a laser generation type light source such as a laser light source instead of a discharging type light source called an ultra high voltage mercury lamp. In other words, the present invention can be applied to a device that enlarges images and projects the enlarged images onto a target to be projected using projected light regardless of the types of the image generation device and the light source.

1. A projection type display device that displays an image with projected light onto a target to be projected, comprising:
a first sensor that detects reflected light of said projected light;
a second sensor that detects an infrared ray in a predetermined range in an optical path direction of said projected light; and
a light amount deciding section that decides an amount of said projected light based on the amount of reflected light detected by said first sensor and an amount of change of the infrared ray detected by said second sensor.

2. The projection type display device as set forth in claim 1, comprising:
a first signal generation section that generates a first signal that represents a value corresponding to the amount of reflected light detected by said first sensor and outputs the generated first signal; and
a second signal generation section that generates a second signal that represents a value corresponding to the amount of change of the infrared ray detected by said second sensor and outputs the generated second signal,
wherein said light amount deciding section decides the amount of said projected light based on a combination of a value represented by the first signal that is output from said first signal generating section and a value represented by the second signal that is output from said second signal generating section.

3. The projection type display device as set forth in claim 2,
wherein said first signal represents a first value when the amount of reflected light detected by said first sensor is greater than a predetermined amount and said first signal represents a second value when the amount of reflected light detected by said first sensor is equal to or lower than said predetermined amount, and
wherein said light amount deciding section sets the amount of said projected light to a predetermined first amount of light when the first signal that is output from said first signal generating section represents said second value and sets the amount of said projected light to an amount of light that decreases said first amount of light corresponding to the value represented by the second signal that is output from said second signal generating section when the first signal represents said first value.

4. The projection type display device as set forth in claim 2,
wherein said second signal represents a first value when the amount of change of the infrared ray detected by said second sensor is greater than a predetermined value and said second signal represents a second value when the amount of change of the infrared ray detected by said second sensor is equal to or lower than said predetermined amount, and
wherein said light amount deciding section sets the amount of said projected light to a predetermined second amount of light when the second signal that is output from said second signal generating section represents said first value and sets the amount of said projected light to an amount of light that increases said second amount of light corresponding to a value represented by the first signal that is output from said first signal generating section when the second signal represents said second value.

5. The projection type display device as set forth in claim 1,
wherein said first sensor and said second sensor are arranged on opposite sides with respect to a boundary of an optical axis of said projected light.

6. An optical amount adjustment method for a projection type display device that displays an image with projected light onto a target to be projected, comprising:
a process that detects reflected light of said projected light;
a process that detects an infrared ray in a predetermined range in an optical path direction of said projected light; and
a light amount deciding process that decides an amount of said projected light based on the amount of reflected light that is detected and an amount of change of the infrared ray that is detected.

7. The optical amount adjustment method as set forth in claim 6, comprising:
a process that generates a first signal that represents a value corresponding to the amount of reflected light that is detected; and
a process that generates a second signal that represents a value corresponding to the amount of change of the infrared ray that is detected,
wherein said light amount deciding process is a process that decides the amount of said projected light based on a combination of a value represented by the first signal that is generated and a value represented by the second signal that is generated.

8. The optical amount adjustment method as set forth in claim 7,
wherein said first signal represents a first value when the amount of reflected light that is detected is greater than a predetermined amount and said first signal represents a second value when the amount of reflected light that is detected is equal to or lower than said predetermined amount, and
wherein said light amount deciding process is a process that sets the amount of said projected light to a predetermined first amount of light when the first signal that is generated represents said second value and that sets the amount of said projected light to an amount of light that decreases said first amount of light corresponding to the value represented by the second signal that is generated when the first signal represents said first value.

9. The optical amount adjustment method as set forth in claim 7,
wherein said second signal represents a first value when the amount of change of the infrared ray that is detected is greater than a predetermined value and said second signal represents a second value when the amount of change of the infrared ray that is detected is equal to or lower than said predetermined amount, and
wherein said light amount deciding process is a process that sets the amount of said projected light to a predetermined second amount of light when the second signal that is generated represents said first value and that sets the amount of said projected light to an amount of light that increases said second amount of light corresponding to a value represented by the first signal that is generated when the second signal represents said second value.

10. The projection type display device as set forth in claim 2,
wherein said first sensor and said second sensor are arranged on opposite sides with respect to a boundary of an optical axis of said projected light.

11. The projection type display device as set forth in claim 3,
wherein said first sensor and said second sensor are arranged on opposite sides with respect to a boundary of an optical axis of said projected light.

12. The projection type display device as set forth in claim 4,
wherein said first sensor and said second sensor are arranged on opposite sides with respect to a boundary of an optical axis of said projected light.
